(19) United States
(12) Patent Application Publication
(10) Pub. No.: US 2026/0205370 A1
(43) Pub. Date: Jul. 16, 2026

(54) SYSTEMS AND METHODS FOR PREDICTIVE END-TO-END ANALYTICS IN A WIRELESS NETWORK

(71) Applicant: Verizon Patent and Licensing Inc., Basking Ridge, NJ (US)

(72) Inventors: Peretz Feder, Englewood, NJ (US); Adrian Buckley, Tracy, CA (US); Chin Chiu, Allen, TX (US)

(73) Assignee: Verizon Patent and Licensing Inc., Basking Ridge, NJ (US)

(21) Appl. No.: 19/019,343

(22) Filed: Jan. 13, 2025

(51) Int. Cl. H04L 41/147; H04L 41/5067; H04W 8/22; H04W 24/08

(52) U.S. Cl. CPC H04L 41/147; H04L 41/5067; H04W 8/22; H04W 24/08

(57) ABSTRACT

A system described herein may monitor performance information associated with a wireless network, wherein the performance information is associated with traffic sent or received by one or more User Equipment ("UEs") via the wireless network; generate one or more predictive models based on the monitored performance information; receive a request for Quality of Service ("QoS") capability information; determine, based on the one or more predictive models, conditions under which the wireless network is able to meet one or more thresholds associated with the request, such as QoS or Quality of Experience ("QoE") thresholds; and output, in response to the request, an indication of the conditions under which the wireless network is able to meet the one or more QoS thresholds. The system may be or may include a Network Data Analytics Function ("NWDAF") of the wireless network.

### BACKGROUND

Wireless networks provide wireless connectivity to User Equipment ("UEs"), such as mobile telephones, tablets, Internet of Things ("IoT") devices, Machine-to-Machine ("M2M") devices, or the like. UEs may receive different services via the wireless networks, such as voice call services, videoconferencing services, gaming services, content streaming services, automated guided vehicle ("AGV") control services, augmented reality ("AR") services, or other types of services. These different services may be associated with different Quality of Service ("QoS") thresholds or Service Level Agreements ("SLAs"), such as minimum throughput thresholds, maximum latency thresholds, maximum packet error rate thresholds, and/or other types of thresholds or parameters.

Additionally, or alternatively, different services may be associated with different measures of Quality of Experience ("QoE"), which may be derived from or based on QoS thresholds or SLAs for different services. For example, a measure of QoE (e.g., a score such as a Mean Opinion Score ("MOS")) for a voice call service may be different from a measure of QoE for a content streaming service, under the same network conditions. The QoE for the voice call service may, for instance, be generated or weighted differently than the QoE for the content streaming service, such as a heavier weight or emphasis on latency for the voice call service than for the content streaming service.

### BRIEF DESCRIPTION OF THE DRAWINGS

FIG. 1 illustrates an example overview of one or more embodiments described herein;

FIGS. 2 and 3 illustrate examples of end-to-end monitoring of QoS metrics in a wireless network, in accordance with some embodiments;

FIGS. 4 and 5 illustrate processes for generating and providing predictive end-to-end QoS and/or QoE analytics in a wireless network, in accordance with some embodiments;

FIGS. 6 and 7 illustrate example environments in which one or more embodiments, described herein, may be implemented;

FIG. 8 illustrates an example arrangement of a radio access network ("RAN"), in accordance with some embodiments;

FIG. 9 illustrates an example arrangement of an Open RAN ("O-RAN") environment in which one or more embodiments, described herein, may be implemented; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements. As discussed herein, one or more elements of a wireless network may be enhanced to generate predictive QoE models associated with the wireless network based on monitoring end-to-end performance metrics, such as latency, throughput, and/or other suitable performance metrics, Key Performance Indicators ("KPIs"), or the like. For example, as described herein, a Network Function ("NF") of a Fifth Generation ("5G") core ("5GC") network, such as a Network Data Analytics Function ("NWDAF"), may receive performance information associated with communication links between User Equipment ("UEs") and a RAN and/or may receive performance information associated with communication links between the RAN and the core network.

The performance information associated with communication links between a given UE and the RAN may, for example, include uplink and/or downlink latency, throughput, etc. of traffic or other signals sent wirelessly between the UE and one or more wireless network infrastructure elements of the RAN, such as, but not limited to, a base station (e.g., a Next Generation Node B ("gNB")), a Distributed Unit ("DU"), a radio unit ("RU"), or the like. The performance information associated with communication links between the RAN and the core network may include uplink and/or downlink latency, throughput, etc. of traffic or other signals sent between the RAN (e.g., one or more wireless network infrastructure elements of the RAN such as a base station, a gNB, a DU, a Central Unit ("CU"), etc.) and a gateway of the core network, such as a User Plane Function ("UPF").

In some embodiments, the performance information, associated with communication links between UEs and the RAN and/or the RAN and the core network may include or may be derived from performance information associated with an N1 interface and/or an N3 interface. In some embodiments, performance information associated with the communication link between a UE and the RAN may be determined as a function of performance information associated with an N1 (e.g., a communication link between the UE and an Access and Mobility Management Function ("AMF")) interface and an N2 interface (e.g., a communication link between the RAN and the AMF).

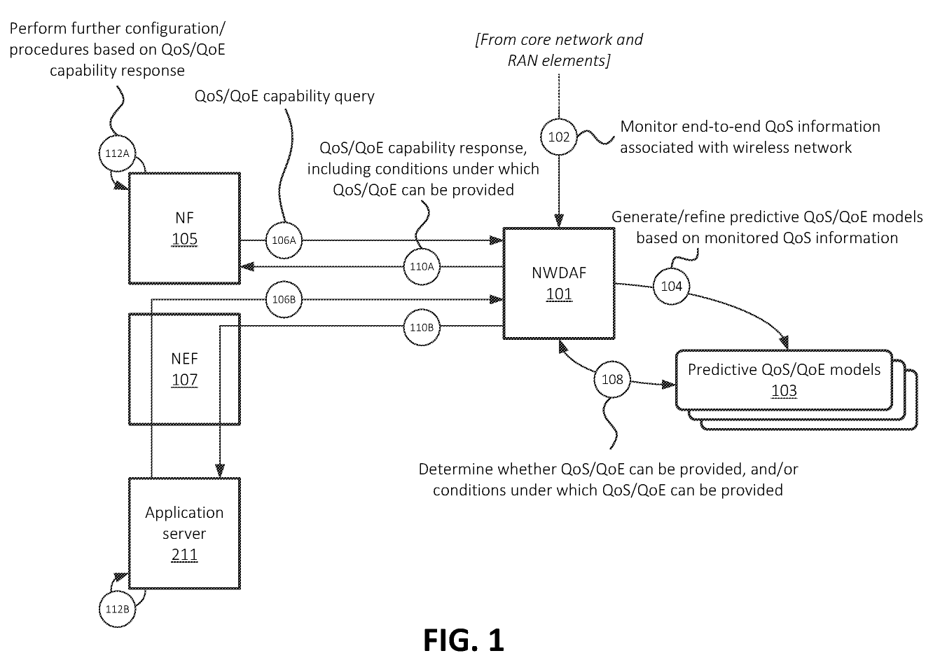

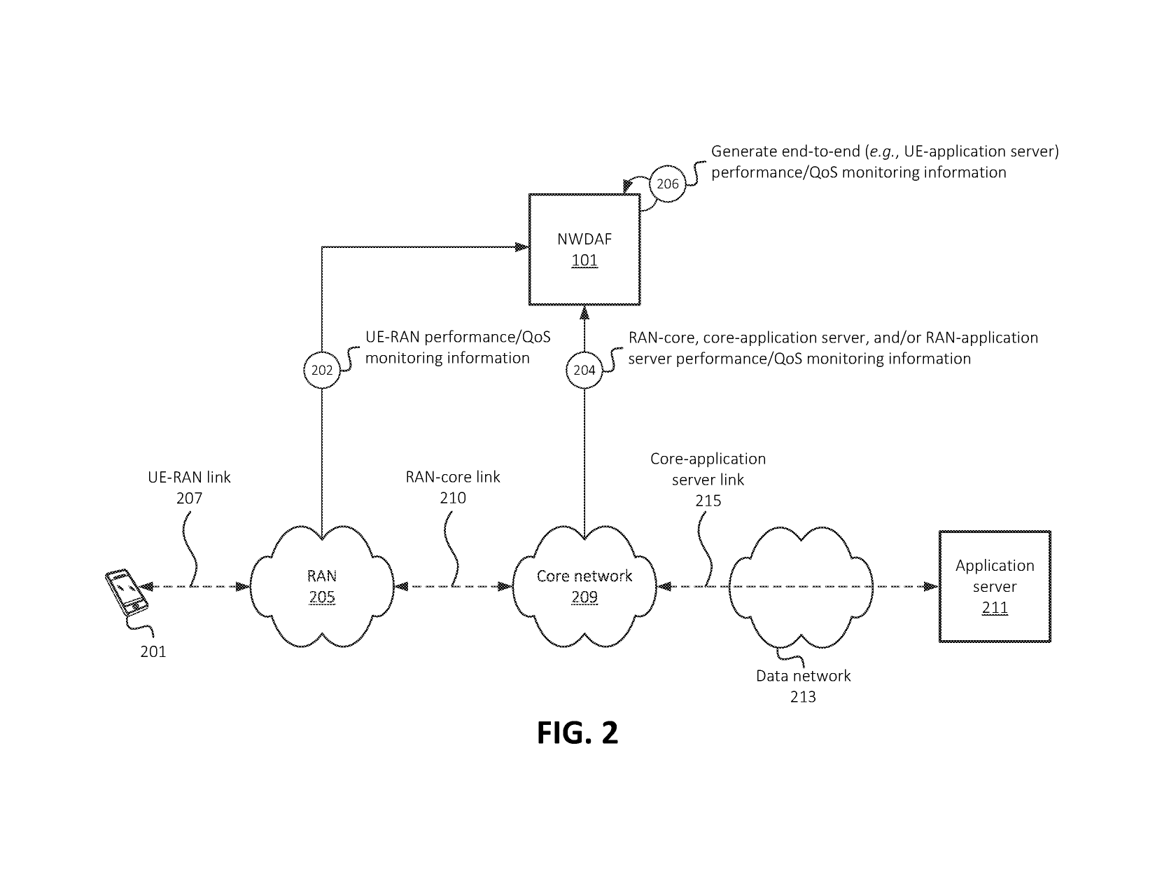

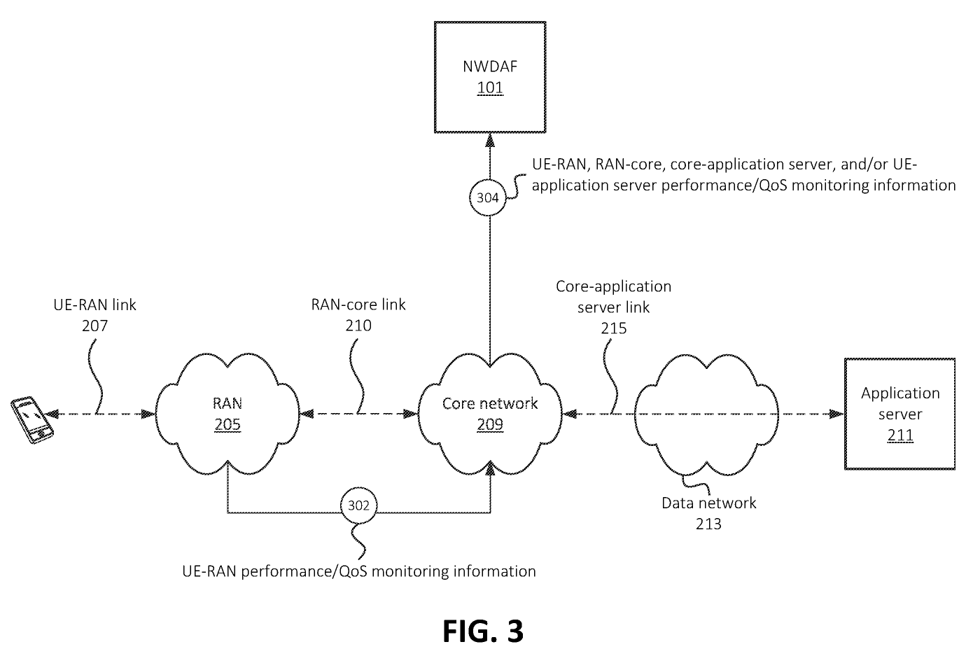

The NWDAF, in accordance with some embodiments, may further receive or monitor performance information associated with other elements of the wireless network and/or with other communication links or interfaces, such as a communication link or interface between the UPF and a data network, and/or a communication link or interface between the UPF and one or more external devices or systems (e.g., an application server providing services to one or more UEs via the UPF). In this manner, as shown in FIG. 1, NWDAF 101 may monitor (at 102) overall end-to-end uplink and/or downlink performance metrics associated with one or more UEs, including performance metrics associated with the entire flow of traffic from UEs to its intended destination, as well as performance metrics associated with the entire flow of traffic from application servers or other devices to particular UEs. Receiving or monitoring the performance information may include outputting, by NWDAF 101 to one or more NFs 105, one or more subscription requests for performance metrics collected, determined, and/or otherwise provided by such NFs 105. FIGS. 2 and 3 further illustrate examples of end-to-end performance monitoring, associated with communications between a particular UE 201 and a particular application server 211, that may be performed by NWDAF 101.

As shown in FIG. 2, for example, UE 201 may be wirelessly connected to RAN 205 (e.g., a base station of RAN 205, a DU of RAN 205, an RU of RAN 205, etc.). UE-RAN link 207 may represent the wireless connection of UE 201 and RAN 205. As such, traffic communicated between UE 201 and RAN 205 may be considered as traversing UE-RAN link 207. UE-RAN link 207 may include one or more radio bearers (e.g., Data Radio Bearers ("DRBs")) or other suitable types of channels or communication pathways. Additionally, communications between RAN 205 and core network 209 (e.g., between a base station of RAN 205 and a UPF of core network 209, as noted above) may be represented as RAN-core link 210. In some embodiments, RAN-core link 210 may include one or more tunnels (e.g., General Packet Radio Service ("GPRS") Tunneling Protocol ("GTP") tunnels) or other suitable types of communication pathways. Core network 209 may provide for routing services, mobility services, etc. for UE 201, such as routing traffic between UE 201 and one or more external networks or devices, such as traffic between UE 201 and application server 211 (e.g., via data network ("DN") 213). Communications between core network 209 and application server 211 are represented as core-application server link 215. As noted above, core-application server link 215 may include DN 213, which may include the Internet and/or one or more other networks.

While discussed in the context of a separate RAN 205, core network 209, and/or application server 211, concepts described herein may be similarly applied in situations where portions of core network 209 and/or application server 211 are implemented locally at RAN 205, such as by a Multi-Access/Mobile Edge Computing ("MEC") device, referred to sometimes herein simply as a "MEC." For example, in some embodiments, a MEC may be deployed locally at a site that implements a base station, a DU, a CU, etc., and the MEC may be configured to implement one or more functions of core network 209 (e.g., UPF functionality) and/or one or more functions of application server 211 (e.g., providing services to UE 201). In such embodiments, end-to-end performance metrics may be determined based on, for example, performance metrics associated with UE-RAN link 207 as well as any internal links or communication pathways of RAN 205 (e.g., inasmuch as such internal links or communication pathways may be used for traffic between UE 201 and the MEC).

As shown in FIG. 2, NWDAF 101 may receive (at 202) UE-RAN performance and/or QoS monitoring information from RAN 205. As noted above, the performance and/or QoS monitoring information may include uplink latency, downlink latency, uplink throughput, downlink throughput, round-trip latency, and/or other suitable performance and/or QoS information. End-to-end performance and/or QoS monitoring information may include or may be based on the UE-RAN performance and/or QoS monitoring information.

In some embodiments, NWDAF 101 may receive the UE-RAN performance and/or QoS monitoring information from one or more elements of RAN 205, such as a base station, a DU, a CU, a RAN controller associated with RAN 205 such as a RAN Intelligent Controller ("RIC"), and/or some other suitable element of RAN 205.

As further shown in FIG. 2, NWDAF 101 may receive (at 204) RAN-core performance and/or QoS monitoring information (e.g., associated with RAN-core link 210) from one or more elements of core network 209, such as a UPF. Additionally, in some embodiments, NWDAF 101 may receive RAN-application server performance and/or QoS monitoring information (e.g., associated with core-application server link 215) from one or more elements of core network 209, such as the UPF. In some embodiments, in order to receive the performance and/or QoS monitoring information (e.g., from RAN 205 and/or from core network 209), NWDAF 101 may output one or more subscription requests (e.g., via one or more Service-Based Interfaces ("SBIs")) to one or more elements of RAN 205 and/or of core network 209 (e.g., to a base station of RAN 205, a DU of RAN 205, a CU of RAN 205, to a RAN controller of 205, to a UPF of core network 209, and/or to another NF 105 of core network 209). NWDAF 101 may generate or determine (at 206) end-to-end performance and/or QoS metrics for traffic associated with a given UE 201 based on information received (at 202 and 204) from RAN 205 and/or core network 209, such as by generating or determining performance and/or QoS metrics associated with UE-RAN link 207, RAN-core link 210, a link between UE 201 and core network 209 (e.g., a UE-PDU Session Anchor ("PSA") link), and/or one or more other suitable links or communication pathways. End-to-end performance and/or QoS monitoring information may include or may be based on the RAN-core performance and/or QoS monitoring information and/or other information (e.g., UE-RAN performance and/or QoS monitoring information, as discussed above).

As shown in FIG. 3, in some embodiments, one or more elements of core network 209 may receive (at 302) UE-RAN performance and/or QoS monitoring information from one or more elements of RAN 205. In some such embodiments, a UPF of core network 209 may receive UE-RAN performance and/or QoS monitoring information (e.g., associated with UE-RAN link 207) from a base station of RAN 205 and/or some other suitable element of RAN 205, a Session Management Function ("SMF"), and/or some other suitable source. Additionally, or alternatively, the UPF may otherwise derive, calculate, compute, etc. performance and/or QoS monitoring information based on information received from a base station and/or some other suitable element of RAN 205, an SMF, and/or some other suitable source.

In some embodiments, the UPF may output a request or some other type of message (e.g., via an N4) interface to the SMF to monitor performance and/or QoS information, which may facilitate (e.g., based on receiving the request or other type of message) the monitoring of RAN-core performance and/or QoS monitoring information. Core network 209 may provide (at 304) UE-RAN performance and/or QoS information, RAN-core performance and/or QoS information, core-application server performance and/or QoS information, and/or some combination or derivation thereof to NWDAF 101. In some embodiments, NWDAF 101 and/or one or more elements of core network 209 may generate or determine end-to-end performance and/or QoS metrics for traffic associated with a given UE 201 by generating or determining performance and/or QoS metrics associated with UE-RAN link 207, RAN-core link 210, a link between UE 201 and core network 209 (e.g., a UE-PDU PSA link), and/or one or more other suitable links or communication pathways.

In some embodiments, the performance and/or QoS monitoring information (e.g., as referred to in FIGS. 1-3) may include UE identifiers, such as a public user identity, a Mobile Directory Number ("MDN"), a private user identity, an International Mobile Subscriber Identity ("IMSI") value, an International Mobile Station Equipment Identity ("IMEI") value, a Subscription Permanent Identifier ("SUPI"), a Globally Unique Temporary Identifier ("GUTI"), an Internet Protocol ("IP") address, and/or other one or more other suitable identifiers based on which one or more UEs 201 may be uniquely identified. Additionally, or alternatively, the performance and/or QoS monitoring information may include one or more session identifiers, such as one or more protocol data unit ("PDU") session identifiers, one or more flow identifiers, or the like. Additionally, or alternatively, the performance and/or QoS monitoring information may include one or more network slice identifiers, such as one or more Network Slice Selection Assistance Information ("NSSAI") values. In some embodiments, the performance and/or QoS monitoring information may include other information, such as timestamps, cell identifiers, location information, or the like.

In this manner, NWDAF 101 may be able to generate or determine end-to-end performance and/or QoS metrics on a per-UE basis, on a per-flow basis, on a per-session basis, on a per-base station basis, on a per-location basis (e.g., where location may be indicated as a cell identifier, a Tracking Area Code ("TAC"), Location Area Code ("LAC"), Routing Area Code ("RAC"), latitude and longitude coordinates, Area of Interest ("AoI"), and/or some other suitable indication of location), on a temporal basis, on a slice basis, or the like. Location, as referred to herein, may refer to the location of a given UE 201 and/or to the location of a given RAN 205 (and/or of one or more elements thereof) to which UE 201 is connected.

For example, returning to FIG. 1, NWDAF 101 may generate and/or refine (at 104) one or more predictive QoS and/or QoE models 103. NWDAF 101 may utilize, for example, artificial intelligence/machine learning ("AI/ML") techniques or other suitable techniques to generate predictive QoS and/or QoE models 103 based on the monitored (at 102) end-to-end performance and/or QoS information associated with communications sent or received via the wireless network. In some embodiments, generating or refining the one or more predictive QoS and/or QoE models 103 may include statistically measuring and/or predicting, computing, calculating, etc. measures of performance under certain conditions (e.g., temporal conditions, location-based conditions, and/or other suitable conditions), as discussed below.

In one example, a particular predictive QoS and/or QoE model 103 may indicate times (e.g., times of the day, days of the week, etc.) at which certain performance information is predicted or expected. For example, a particular predictive QoS and/or QoE model 103 may be generated based on monitored performance and/or QoS information indicating that a particular base station and/or other network element provides a relatively high measure of latency and/or a relatively low measure of throughput during daytime hours (e.g., 9:00AM through 6:00PM) and provides a relatively low measure of latency and/or a relatively high measure of throughput during other times (e.g., 6:00PM through 9:00AM). As another example, one or more predictive QoS and/or QoE models 103 may indicate that a first base station or geographical location is associated with a relatively high measure of latency and/or a relatively low measure of throughput, whereas a second base station or geographical location is associated with a relatively low measure of latency and/or a relatively high measure of throughput. As another example, one or more predictive QoS and/or QoE models 103 may indicate that one of the allowed slices is associated with a relatively high measure of latency and/or a relatively low measure of throughput, whereas another allowed slice is associated with a relatively low measure of latency and/or a relatively high measure of throughput. In practice, predictive QoS and/or QoE models 103 may be generated based on a combination of time, location, network slice and/or based on one or more other suitable factors.

As such, predictive QoS and/or QoE models 103 may be used to determine one or more expected or predicted measures of performance given certain conditions. For example, predictive QoS and/or QoE models 103 may indicate expected or predicted measure of latency, throughput, and/or other suitable measures of performance at certain times, certain locations, and/or certain network slices. Additionally, or alternatively, predictive QoS and/or QoE models 103 may be used to determine measures of QoE, for particular services or applications, under certain conditions (e.g., time, location, new slice, etc.). In some embodiments, a measure of QoE (referred to herein as a "QoE score") for different applications may be determined by applying different weights, coefficients, transformation, functions, etc. to monitored performance and/or QoS information. For example, a QoE score for a first service (e.g., a voice call service) may be determined based on a relatively high weight or coefficient for uplink and/or downlink latency and a relatively low weight or coefficient for uplink and/or downlink throughput. On the other hand, a QoE score for a second service (e.g., a content streaming service) may be determined by a relatively high weight or coefficient for downlink throughput, and a relatively low weight or coefficient for uplink throughput, uplink latency, and/or downlink latency.

In some embodiments, NWDAF 101 may, for example, be configured to generate, calculate, compute, predict, etc. different QoE scores for different services. Additionally, or alternatively, NWDAF 101 may receive computation information (e.g., formulas, coefficients, weights, etc.) for a given QoE score along with a request to compute the QoE score and/or some other suitable request. For example, as shown in FIG. 1, NWDAF 101 may receive a QoS and/or QoE capability query. In some embodiments, NWDAF 101 may receive (at 106A) the QoS and/or QoE capability query (e.g., may receive one or more messages) from one or more network functions ("NFs") 105, such as an SMF, a Policy Control Function ("PCF"), an AMF, and/or some other suitable NF of the wireless network. As one example, NF 105 (e.g., the SMF and/or PCF) may output (at 106A) the QoS and/or QoE capability query (e.g., send one or more messages) based on a connection of UE 201 to RAN 205, a handover of UE 201 to RAN 205, a requested connection or handover of UE 201 to RAN 205, a communication session establishment request (e.g., a PDU session establishment request) initiated by or on behalf of UE 201, and/or based on some other suitable triggering event. Generally, the QoS and/or QoE capability query from NF 105 may be made in order to determine whether the wireless network is able to provide at least a threshold measure of QoS or QoE (e.g., a maximum latency, a minimum throughput, a Packet Delay Budget ("PDB"), etc.), such as a threshold measure of QoS or QoE associated with UE information (e.g., UE subscription information maintained by one or more UE information repositories of the wireless network such as a Unified Data Management function ("UDM") or Unified Data Repository ("UDR")). In some embodiments, the QoS and/or QoE capability query from NF 105 may be made in order to determine a measure of likelihood (e.g., a prediction determined using AI/ML techniques or other suitable techniques) that the wireless network will be able to provide under one or more conditions. Such conditions may include, for example, a predicted amount of UE demand at a particular time and/or location, a predicted amount of demand for a particular service or a particular network slice, and/or other suitable conditions. In some embodiments, the QoS and/or QoE capability query may specify certain conditions (e.g., time, location, network slice, and/or other conditions), which may ultimately be used by NWDAF 101 to determine an appropriate response, as discussed below.

As another example, the QoS and/or QoE capability query from NF 105 may be made in order to determine whether the wireless network is able to provide a threshold measure of QoS or QoE associated with a particular service for UE 201, a particular network slice, etc.

In some embodiments, the QoS and/or QoE capability query may be made as part of a session management or other policy-based procedure, in which an indication of whether the wireless network is able to meet a threshold PDB or some other QoS or QoE threshold, is used in determining how to perform the session management or other policy-based procedure. In one example, a particular application or service type may be associated with a threshold PDB, and NF 105 may include an SMF and/or a PCF that participate in a session establishment procedure that is associated with the particular application or service type. For example, if the wireless network is (and/or is predicted to be) able to meet the threshold PDB for the particular application or service type, NF 105 may proceed with, may facilitate, etc. the session establishment procedure. On the other hand, if the wireless network is (and/or is predicted to be) unable to meet the threshold PDB for the particular application or service type, NF 105 may reject, delay, modify, and/or otherwise not proceed with the session establishment procedure. As discussed below, if the wireless network is unable to meet the threshold PDB at a given time, NF 105 may receive alternate conditions (e.g., an alternate time, location, etc.) under which the wireless network would be able to meet the threshold PDB.

As another example, NWDAF 101 may receive (at 106B) the QoS and/or QoE capability from application server 211, which may provide services to UE 201 and/or for which services are being requested to be provided to UE 201. In some embodiments, NWDAF 101 may receive (at 106B) the QoS and/or QoE capability query from application server 211 via Network Exposure Function ("NEF") 107 or some other suitable interface between the core network and external devices or systems. For example, application server 211 may output a request for QoS and/or QoE capability information to NEF 107, and NEF 107 may accordingly forward a corresponding request for QoS and/or QoE capability information to NWDAF 101. In some embodiments, the request from NEF 107 may specify some or all of the information included in the QoS and/or QoE capability information from application server 211, which may include specific conditions, QoS and/or QoE thresholds, etc. In some embodiments, the request from NEF 107 may include one or more identifiers of application server 211.

In one example, the QoS and/or QoE capability query from application server 211 may be made in order to determine whether the wireless network is able to provide a threshold measure of QoS or QoE associated with a particular service provided by application server 211 to UE 201.

In some embodiments, the QoS and/or QoE capability query (at 106A and/or 106B) may specify one or more parameters, such as temporal parameters, location-based parameters, and/or network slice-based parameters. Generally, for example, the QoS and/or QoE capability query may be made in order to determine whether the wireless network is able to provide at least a threshold measure of QoS and/or QoE at a certain location (e.g., a particular TAC, RAC, LAC, latitude and longitude coordinates, etc.), at a certain time (e.g., a specific time of day, a specific day of the week, etc.), and/or via a particular serving slice.

In some embodiments, the QoS and/or QoE capability query (at 106A and/or 106B) may be an "open-ended" request with respect to any particular QoS and/or QoE thresholds. For example, the QoS and/or QoE capability query may made in order to determine what the predicted measures of QoS and/or QoE are at a given time (e.g., a future time) and/or at a given location.

In some embodiments, the query (at 106A and/or 106B) may be a one-time request for QoS and/or QoE capability information. In some embodiments, the query (at 106A and/or 106B) may include a subscription for QoS and/or QoE capability information, such as a request to provide QoS and/or QoE capability information on an ongoing basis, on a periodic basis, on an event-driven basis, and/or on some other suitable basis.

NWDAF 101 may determine (at 108) QoS and/or QoE information based on the request(s) from NF 105, NEF 107, and/or application server 211. For example, NWDAF 101 may determine, based on predictive QoS and/or QoE models 103, QoS and/or QoE information associated with a given time or location indicated in the request(s). In the event that a particular QoS and/or QoE capability information request specifies specific QoS and/or QoE thresholds (e.g., a maximum latency, a minimum throughput, a PDB, a minimum QoE score, etc.) and/or other conditions (e.g., a location, a time, new slice, etc.), NWDAF 101 may determine (e.g., predict, based on predictive QoS and/or QoE models 103) whether the wireless network is able to meet or exceed such QoS and/or QoE thresholds (e.g., whether the wireless network is able to meet or satisfy a PDB or some other suitable threshold).

In the event that the wireless network is not able to provide the requested measures of QoS and/or QoE, NWDAF 101 may further utilize predictive QoS and/or QoE models 103 to determine conditions under which the wireless network is able to provide the requested measures of QoS and/or QoE. For example, NWDAF 101 may determine that the wireless network is able to provide the requested measures of QoS and/or QoE at a different time and/or location, or via a different network slice, than the time, location, and/or network slice indicated in the capability request.

NWDAF 101 may output (at 110A and/or 110B) a QoS and/or QoE capability response (e.g., may send one or more messages). In some embodiments, the QoS and/or QoE capability response may be a binary response (e.g., "yes" or "no"), such as an indication that the wireless network can (or cannot) support (e.g., based on a prediction performed based on predictive QoS and/or QoE models 103) a requested measure of QoS and/or QoE. In some embodiments, the QoS and/or QoE capability response (e.g., one or more messages sent at 110A or 110B) may indicate conditions under which the wireless network can support the requested measure of QoS and/or QoE. In some situations, this response may indicate different times, different locations, different times and locations, different allowed slice, and/or one or more other different conditions than are included in the QoS and/or QoE capability request.

NF 105 and/or application server 211 may accordingly perform (at 112A and/or 112B, respectively) further configuration and/or other procedures based on the QoS and/or QoE capability response. In an example where NF 105 includes an SMF that sent (at 106A) the request based on a session establishment request associated with UE 201, the SMF may determine whether to proceed with the session establishment request, reject the session establishment request, or perform alternate procedures with respect to the session establishment request. In some implementations, the alternate procedures may include rejecting (e.g., by the SMF) the session establishment request with an indication or cause code indicating that a requested measure of QoS and/or QoE could not be provided by the wireless network. In some implementations, the alternate procedures may include rejecting (e.g., by the SMF) the session establishment request with an indication or cause code indicating an alternate time, location, and/or network slice via which the wireless network is able to provide the requested measure of QoS and/or QoE could not be provided by the wireless network. In some implementations, the alternate procedures may include selecting different parameters or sets of parameters (e.g., "one-to-many" parameter sets), such as a different network slice and/or other parameters that are associated with a measure of QoS and/or QoE that is able to be met by the wireless network. In some embodiments, the alternate procedures may include modifying resource allocations or other configuration parameters of one or more elements of RAN 205 and/or core network 209, such as to reduce latency or increase throughput at times or locations of predicted high latency and/or low throughput. In some scenarios, the resource allocation or configuration parameter modifications may be performed at times different from times or timeframes indicated in a QoS and/or QoE capability request.

Similarly, a response to application server 211 indicating alternate times, locations, and/or network slices at which measure of QoS and/or QoE (e.g., PDB threshold, minimum threshold throughput, maximum threshold latency, minimum QoE score, etc.) that is able to be met by the wireless network may facilitate application server 211 in selecting (at 112B) alternate application-level parameters, such as a time at which to provide a service, bitrate of services provided by application server 211, or other suitable parameters.

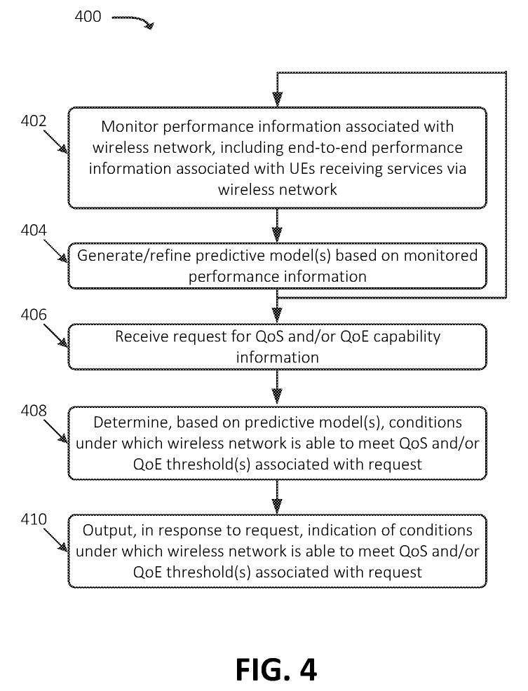

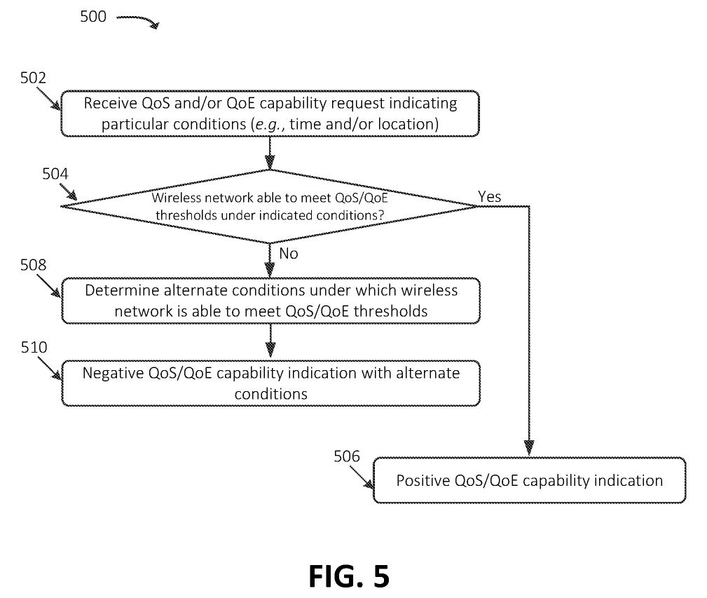

FIGS. 4 and 5 illustrate processes 400 and 500, respectively, for generating and/or providing predictive end-to-end QoS and/or QoE analytics in a wireless network. In some embodiments, some or all of process 400 may be performed by NWDAF 101. In some embodiments, one or more other devices may perform some or all of process 400 in concert with, and/or in lieu of, NWDAF 101.

As shown in FIG. 4, process 400 may include monitoring (at 402) performance information associated with a wireless network. As discussed above, monitoring the performance information may include outputting one or more subscription requests to one or more NFs 105 and/or otherwise network elements that provide such information. As also discussed above, the performance information may include end-to-end performance information associated with UEs receiving services via the wireless network (e.g., routing services, mobility services, etc.). The end-to-end performance information may include performance information associated with a wireless interface between one or more UEs 201 and RAN 205 of the wireless network, and/or performance information associated with one or more links (e.g., a backhaul link) between RAN 205 and core network 209 of the wireless network. The performance information may include, for example, uplink throughput information, downlink throughput information, uplink latency information, downlink latency information, round-trip latency information, and/or other performance information. As discussed above, the performance information may be monitored on a per-location basis, on a temporal basis, on a per-UE basis, on a per-network slice basis, and/or on some other suitable basis.

Process 400 may further include generating and/or refining (at 404) one or more predictive models (e.g., predictive QoS and/or QoE models 103) based on the monitored performance information. For example, as discussed above, NWDAF may utilize one or more AI/ML techniques or other suitable modeling techniques to generate predictive QoS and/or QoE models 103. Predictive QoS and/or QoE models 103 may include performance information that is predicted under certain conditions, such as temporal conditions (e.g., predicted latency or throughput based on time of day, day of week, etc.), location-based conditions (e.g., predicted latency or throughput for services provided to a given UE 201 based on a location of such UE 201), service-based conditions (e.g., predicted latency or throughput for certain services or service types such as voice call services, videoconferencing services, gaming services, content streaming services, AGV control services, AR services, or other types of services), and/or other conditions or combinations of conditions.

Process 400 may additionally include receiving (at 406) a request for QoS and/or QoE capability information. As discussed above, the request may indicate one or more QoS and/or QoE thresholds, such as a maximum latency, a minimum throughput, a minimum QoE score or the like. In some embodiments, the request may indicate one or more service types or other parameters, based on which one or more QoS and/or QoE thresholds may be determined (e.g., based on a mapping or other information correlating service types to QoS and/or QoE thresholds).

As discussed above, the request may be received from one or more NFs 105 of the wireless network, also sometimes referred to as "consumer" NFs 105. Additionally, or alternatively, the request may be received from one or more other devices or systems, such as application server 211 (e.g., via NEF 107). As noted above, the request may, in some scenarios, include an ongoing request for information, such as a subscription to QoS and/or QoE information associated with certain times, locations, or other parameters.

Process 400 may also include determining (at 408), based on predictive QoS and/or QoE models 103, conditions under which the wireless network is able to meet the QoS and/or QoE thresholds associated with the request. For example, NWDAF 101 may identify conditions such as times (e.g., timeframes), locations (e.g., TACs, LACs, RACs, cell identifiers, etc.), and/or network slices that are indicated in predictive QoS and/or QoE models 103 as being associated with performance information that satisfies the QoS and/or QoE thresholds.

Process 400 may further include outputting (at 410), in response to the request, an indication of conditions under which the wireless network is able to meet the QoS and/or QoE thresholds associated with the request. For example, NWDAF 101 may indicate times, locations, network slices, or other conditions under which the wireless network is able to meet QoS and/or QoE thresholds, such as by providing service with a maximum latency, a minimum throughput, etc. In this manner, the requesting device (e.g., a consumer NF 105, a particular application server 211 that provides or will provide service to one or more UEs 201, etc.) may be made "aware" of such conditions, and may perform configuration modifications or other procedures based on the received indication of conditions under which the QoS and/or QoE thresholds are able to be met by the wireless network.

As shown in FIG. 5, the request received by NWDAF 101 may include an indication of particular conditions, such as time or location (at 502). For example, a consumer NF 105, a particular application server 211, etc. may specify a particular time or timeframe, a particular location or geographical region (e.g., a location or region at which a particular UE 201 or set of UEs 201 are located or will be located at the particular time or during the particular timeframe), and/or other conditions. In some embodiments, the request may specify one or more QoS and/or QoE thresholds, and/or may include information based on which one or more QoS and/or QoE thresholds may be identified (e.g., service type, network slice, etc.).

Process 500 may additionally include determining (at 504) whether the wireless network is able to mee the QoS and/or QoE thresholds associated with the request. For example, NWDAF 101 may identify one or more predictive QoS and/or QoE models 103 that include performance information (e.g., predicted performance information) that meets some or all of the specified conditions. As one example, the request may specify a particular timeframe (e.g., a one-minute timeframe, a two-hour timeframe, a one-day timeframe, etc.) and location, and NWDAF may identify one or more predictive QoS and/or QoE models 103 that include predicted performance information for the particular timeframe and location.

In the event that the wireless network is able to (and/or is predicted to be able to) meet the QoS and/or QoE thresholds associated with the request and the specified conditions (at 504 – YES), NWDAF 101 may output (at 506) a positive QoS and/or QoE capability indication. The positive QoS and/or QoE capability indication may signify that the wireless network is able to meet the QoS and/or QoE thresholds associated with the request. As such, a requesting device (e.g., a consumer NF 105, a particular application server 211), etc. may perform operations such as continuing with a session establishment request, providing a service to UE 201, or the like.

If, on the other hand, the wireless network is not able (e.g., is unable) to (and/or is predicted to be unable to) meet the QoS and/or QoE thresholds associated with the request and the specified conditions (at 504 – NO), NWDAF 101 may determine (at 508) alternate conditions under which the wireless network is able to meet the QoS and/or QoE thresholds. For example, NWDAF 101 may identify, based on predictive QoS and/or QoE models 103, that the wireless network would be able to meet the QoS thresholds at one or more different times or timeframes than one or more times or timeframes specified in the request, and/or at one or more different locations than one or more locations specified in the request. As another example, NWDAF 101 may identify an alternate network slice of the wireless network, via which the wireless network would be able to meet the QoS and/or QoE thresholds.

Process 500 may also include outputting (at 510) a negative QoS and/or QoE capability indication, which may signify that the wireless network is (or is not predicted to) not able to meet the QoS and/or QoE thresholds associated with the request under the specified conditions. In accordance with some embodiments, the negative QoS and/or QoE capability indication may include, or may be provided with, an indication of the alternate conditions under which the wireless network is able to meet the QoS and/or QoE thresholds. In this manner, the requesting device (e.g., a consumer NF 105, a particular application server 211, etc.) may be provided with more useful information to ultimately enhance the services provided to one or more UEs 201 by the requesting device, such as by performing further configuration modifications or other operations that leverage the additional information provided (e.g., the alternate conditions provided in addition to or in conjunction with the negative QoS and/or QoE capability indication).

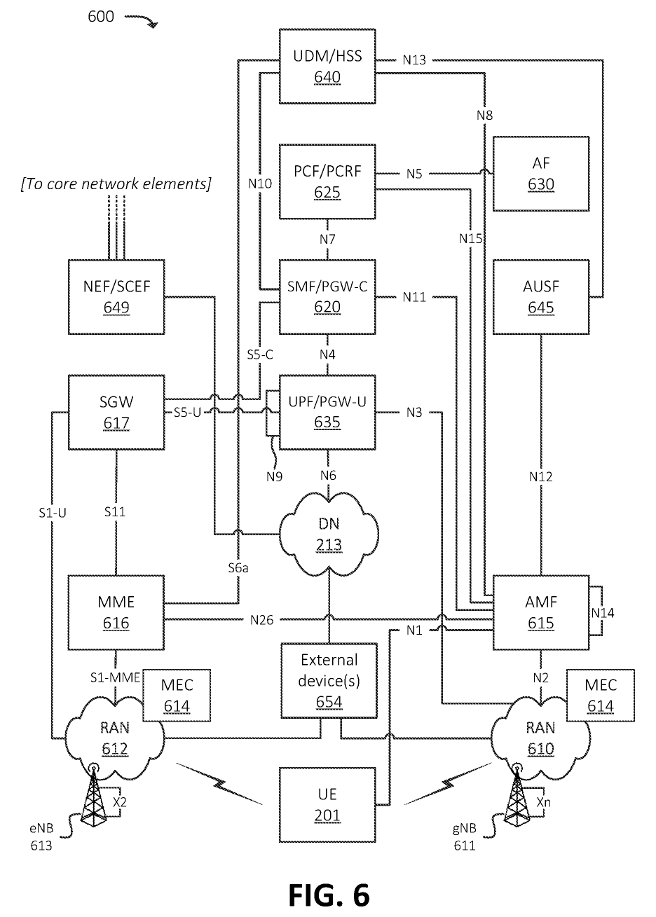

FIG. 6 illustrates an example environment 600, in which one or more embodiments may be implemented. In some embodiments, environment 600 may correspond to a Fifth Generation ("5G") network, and/or may include elements of a 5G network. In some embodiments, environment 600 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 600 may represent or may include a 5GC. As shown, environment 600 may include UE 201, RAN 610 (which may include one or more Next Generation Node Bs ("gNBs") 611), RAN 612 (which may include one or more evolved Node Bs ("eNBs") 613), and various network functions such as Access and Mobility Management Function ("AMF") 615, Mobility Management Entity ("MME") 616, Serving Gateway ("SGW") 617, SMF/Packet Data Network ("PDN") Gateway ("PGW")-Control plane function ("PGW-C") 620, PCF/Policy Charging and Rules Function ("PCRF") 625, Application Function ("AF") 630, UPF/PGW-User plane function ("PGW-U") 635, UDM/Home Subscriber Server ("HSS") 640, Authentication Server Function ("AUSF") 645, and NEF/Service Capability Exposure Function ("SCEF") 649. Environment 600 may also include one or more networks, such as Data Network ("DN") 213. Environment 600 may include one or more additional devices or systems communicatively coupled to one or more networks (e.g., DN 213), such as one or more external devices 654.

The example shown in FIG. 6 illustrates one instance of each network component or function (e.g., one instance of SMF/PGW-C 620, PCF/PCRF 625, UPF/PGW-U 635, UDM/HSS 640, and/or AUSF 645). In practice, environment 600 may include multiple instances of such components or functions. For example, in some embodiments, environment 600 may include multiple "slices" of a core network, where each slice includes a discrete and/or logical set of network functions (e.g., one slice may include a first instance of AMF 615, SMF/PGW-C 620, PCF/PCRF 625, and/or UPF/PGW-U 635, while another slice may include a second instance of AMF 615, SMF/PGW-C 620, PCF/PCRF 625, and/or UPF/PGW-U 635). The different slices may provide differentiated levels of service, such as service in accordance with different Quality of Service ("QoS") parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Additionally, one or more elements of environment 600 may be implemented in a virtualized and/or containerized manner. For example, one or more of the elements of environment 600 may be implemented by one or more Virtualized Network Functions ("VNFs"), Cloud-Native Network Functions ("CNFs"), etc. In such embodiments, environment 600 may include, may implement, and/or may be communicatively coupled to an orchestration platform that provisions hardware resources, installs containers or applications, performs load balancing, and/or otherwise manages the deployment of such elements of environment 600. In some embodiments, such orchestration and/or management of such elements of environment 600 may be performed by, or in conjunction with, the open-source Kubernetes^{®} application programming interface ("API") or some other suitable virtualization, containerization, and/or orchestration system.

Elements of environment 600 may interconnect with each other and/or other devices via wired connections, wireless connections, or a combination of wired and wireless connections. Examples of interfaces or communication pathways between the elements of environment 600, as shown in FIG. 6, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 6, such as Service-Based Interfaces ("SBIs"), including an Namf interface, an Nudm interface, an Npcf interface, an Nupf interface, an Nnef interface, an Nsmf interface, and/or one or more other SBIs.

UE 201 may include a computation and communication device, such as a wireless mobile communication device that is capable of communicating with RAN 610, RAN 612, and/or DN 213. UE 201 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 201 may send traffic to and/or receive traffic (e.g., user plane traffic) from DN 213 via RAN 610, RAN 612, and/or UPF/PGW-U 635.

RAN 610 may be, or may include, a 5G RAN that implements a 5G RAT and that includes one or more base stations (e.g., one or more gNBs 611), via which UE 201 may communicate with one or more other elements of environment 600. UE 201 may communicate with RAN 610 via an air interface (e.g., as provided by gNB 611). For instance, RAN 610 may receive traffic (e.g., user plane traffic such as voice call traffic, data traffic, messaging traffic, etc.) from UE 201 via the air interface, and may communicate the traffic to UPF/PGW-U 635 and/or one or more other devices or networks. Further, RAN 610 may receive signaling traffic, control plane traffic, etc. from UE 201 via the air interface, and may communicate such signaling traffic, control plane traffic, etc. to AMF 615 and/or one or more other devices or networks. Additionally, RAN 610 may receive traffic intended for UE 201 (e.g., from UPF/PGW-U 635, AMF 615, and/or one or more other devices or networks) and may communicate the traffic to UE 201 via the air interface. In some embodiments, RAN 205 may be, may include, and/or may be implemented by RAN 610.

RAN 612 may be, or may include, an LTE RAN that implements an LTE RAT and that includes one or more base stations (e.g., one or more eNBs 613), via which UE 201 may communicate with one or more other elements of environment 600. UE 201 may communicate with RAN 612 via an air interface (e.g., as provided by eNB 613). For instance, RAN 612 may receive traffic (e.g., user plane traffic such as voice call traffic, data traffic, messaging traffic, signaling traffic, etc.) from UE 201 via the air interface, and may communicate the traffic to UPF/PGW-U 635 (e.g., via SGW 617) and/or one or more other devices or networks. Further, RAN 612 may receive signaling traffic, control plane traffic, etc. from UE 201 via the air interface, and may communicate such signaling traffic, control plane traffic, etc. to MME 616 and/or one or more other devices or networks. Additionally, RAN 612 may receive traffic intended for UE 201 (e.g., from UPF/PGW-U 635, MME 616, SGW 617, and/or one or more other devices or networks) and may communicate the traffic to UE 201 via the air interface. In some embodiments, RAN 205 may be, may include, and/or may be implemented by RAN 612.

One or more RANs of environment 600 (e.g., RAN 610 and/or RAN 612) may include, may implement, and/or may otherwise be communicatively coupled to one or more edge computing devices, such as one or MECs 614. MECs 614 may be co-located with wireless network infrastructure equipment of RANs 610 and/or 612 (e.g., one or more gNBs 611 and/or one or more eNBs 613, respectively). Additionally, or alternatively, MECs 614 may otherwise be associated with geographical regions (e.g., coverage areas) of wireless network infrastructure equipment of RANs 610 and/or 612. In some embodiments, one or more MECs 614 may be implemented by the same set of hardware resources, the same set of devices, etc. that implement wireless network infrastructure equipment of RANs 610 and/or 612. In some embodiments, one or more MECs 614 may be implemented by different hardware resources, a different set of devices, etc. from hardware resources or devices that implement wireless network infrastructure equipment of RANs 610 and/or 612. In some embodiments, MECs 614 may be communicatively coupled to wireless network infrastructure equipment of RANs 610 and/or 612 (e.g., via a high-speed and/or low-latency link such as a physical wired interface, a high-speed and/or low-latency wireless interface, or some other suitable communication pathway).

MECs 614 may include hardware resources (e.g., configurable or provisionable hardware resources) that may be configured to provide services and/or otherwise process traffic to and/or from UE 201, via RAN 610 and/or 612. For example, RAN 610 and/or 612 may route some traffic from UE 201 (e.g., traffic associated with one or more particular services, applications, application types, etc.) to a respective MEC 614 instead of to core network elements of 600 (e.g., UPF/PGW-U 635). MEC 614 may accordingly provide services to UE 201 by processing such traffic, performing one or more computations based on the received traffic, and providing traffic to UE 201 via RAN 610 and/or 612. MEC 614 may include, and/or may implement, some or all of the functionality described above with respect to UPF/PGW-U 635, AF 630, one or more application servers, and/or one or more other devices, systems, VNFs, CNFs, etc. In this manner, ultra-low latency services may be provided to UE 201, as traffic does not need to traverse links (e.g., backhaul links) between RAN 610 and/or 612 and the core network.

AMF 615 may include one or more devices, systems, VNFs, CNFs, etc., that perform operations to register UE 201 with the 5G network, to establish bearer channels associated with a session with UE 201, to hand off UE 201 from the 5G network to another network, to hand off UE 201 from the other network to the 5G network, manage mobility of UE 201 between RANs 610 and/or gNBs 611, and/or to perform other operations. In some embodiments, the 5G network may include multiple AMFs 615, which communicate with each other via the N14 interface (denoted in FIG. 6 by the line marked "N14" originating and terminating at AMF 615).

MME 616 may include one or more devices, systems, VNFs, CNFs, etc., that perform operations to register UE 201 with the EPC, to establish bearer channels associated with a session with UE 201, to hand off UE 201 from the EPC to another network, to hand off UE 201 from another network to the EPC, manage mobility of UE 201 between RANs 612 and/or eNBs 613, and/or to perform other operations.

SGW 617 may include one or more devices, systems, VNFs, CNFs, etc., that aggregate traffic received from one or more eNBs 613 and send the aggregated traffic to an external network or device via UPF/PGW-U 635. Additionally, SGW 617 may aggregate traffic received from one or more UPF/PGW-Us 635 and may send the aggregated traffic to one or more eNBs 613. SGW 617 may operate as an anchor for the user plane during inter-eNB handovers and as an anchor for mobility between different telecommunication networks or RANs (e.g., RANs 610 and 612).

SMF/PGW-C 620 may include one or more devices, systems, VNFs, CNFs, etc., that gather, process, store, and/or provide information in a manner described herein. SMF/PGW-C 620 may, for example, facilitate the establishment of communication sessions on behalf of UE 201. In some embodiments, the establishment of communications sessions may be performed in accordance with one or more policies provided by PCF/PCRF 625.

PCF/PCRF 625 may include one or more devices, systems, VNFs, CNFs, etc., that aggregate information to and from the 5G network and/or other sources. PCF/PCRF 625 may receive information regarding policies and/or subscriptions from one or more sources, such as subscriber databases and/or from one or more users (such as, for example, an administrator associated with PCF/PCRF 625).

AF 630 may include one or more devices, systems, VNFs, CNFs, etc., that receive, store, and/or provide information that may be used in determining parameters (e.g., quality of service parameters, charging parameters, or the like) for certain applications.

UPF/PGW-U 635 may include one or more devices, systems, VNFs, CNFs, etc., that receive, store, and/or provide data (e.g., user plane data). For example, UPF/PGW-U 635 may receive user plane data (e.g., voice call traffic, data traffic, etc.), destined for UE 201, from DN 213, and may forward the user plane data toward UE 201 (e.g., via RAN 610, SMF/PGW-C 620, and/or one or more other devices). In some embodiments, multiple instances of UPF/PGW-U 635 may be deployed (e.g., in different geographical locations), and the delivery of content to UE 201 may be coordinated via the N9 interface (e.g., as denoted in FIG. 6 by the line marked "N9" originating and terminating at UPF/PGW-U 635). Similarly, UPF/PGW-U 635 may receive traffic from UE 201 (e.g., via RAN 610, RAN 612, SMF/PGW-C 620, and/or one or more other devices), and may forward the traffic toward DN 213. In some embodiments, UPF/PGW-U 635 may communicate (e.g., via the N4 interface) with SMF/PGW-C 620, regarding user plane data processed by UPF/PGW-U 635.

UDM/HSS 640 and AUSF 645 may include one or more devices, systems, VNFs, CNFs, etc., that manage, update, and/or store, in one or more memory devices associated with AUSF 645 and/or UDM/HSS 640, profile information associated with a subscriber. In some embodiments, UDM/HSS 640 may include, may implement, may be communicatively coupled to, and/or may otherwise be associated with some other type of repository or database, such as a UDR. AUSF 645 and/or UDM/HSS 640 may perform authentication, authorization, and/or accounting operations associated with one or more UEs 201 and/or one or more communication sessions associated with one or more UEs 201.

DN 213 may include one or more wired and/or wireless networks. For example, DN 213 may include an Internet Protocol ("IP")-based PDN, a wide area network ("WAN") such as the Internet, a private enterprise network, and/or one or more other networks. UE 201 may communicate, through DN 213, with data servers, other UEs 201, and/or to other servers or applications that are coupled to DN 213. DN 213 may be connected to one or more other networks, such as a public switched telephone network ("PSTN"), a public land mobile network ("PLMN"), and/or another network. DN 213 may be connected to one or more devices, such as content providers, applications, web servers, and/or other devices, with which UE 201 may communicate.

External devices 654 may include one or more devices or systems that communicate with UE 201 via DN 213 and one or more elements of 600 (e.g., via UPF/PGW-U 635). In some embodiments, external devices 654 may include, may implement, and/or may otherwise be associated with application server 211. External devices 654 may include, for example, one or more application servers, content provider systems, web servers, or the like. External devices 654 may, for example, implement "server-side" applications that communicate with "client-side" applications executed by UE 201. External devices 654 may provide services to UE 201 such as gaming services, videoconferencing services, messaging services, email services, web services, and/or other types of services. Operations described above with respect to a given external device 654 (e.g., in accordance with some embodiments) may be performed by a single device, by a cloud computing system, by one or more devices that implement a virtualized or containerized environment, a collection of devices, etc.

In some embodiments, external devices 654 may communicate with one or more elements of environment 600 (e.g., core network elements) via NEF/SCEF 649. NEF/SCEF 649 include one or more devices, systems, VNFs, CNFs, etc. that provide access to information, APIs, and/or other operations or mechanisms of one or more core network elements to devices or systems that are external to the core network (e.g., to external device 654 via DN 213). NEF/SCEF 649 may maintain authorization and/or authentication information associated with such external devices or systems, such that NEF/SCEF 649 is able to provide information, that is authorized to be provided, to the external devices or systems. For example, a given external device 654 may request particular information associated with one or more core network elements. NEF/SCEF 649 may authenticate the request and/or otherwise verify that external device 654 is authorized to receive the information, and may request, obtain, or otherwise receive the information from the one or more core network elements. In some embodiments, NEF/SCEF 649 may include, may implement, may be implemented by, may be communicatively coupled to, and/or may otherwise be associated with a Security Edge Protection Proxy ("SEPP"), which may perform some or all of the functions discussed above. External device 654 may, in some situations, subscribe to particular types of requested information provided by the one or more core network elements, and the one or more core network elements may provide (e.g., "push") the requested information to NEF/SCEF 649 (e.g., in a periodic or otherwise ongoing basis).

In some embodiments, external devices 654 may communicate with one or more elements of RAN 610 and/or 612 via an API or other suitable interface. For example, a given external device 654 may provide instructions, requests, etc. to RAN 610 and/or 612 to provide one or more services via one or more respective MECs 614. In some embodiments, such instructions, requests, etc. may include QoS parameters, Service Level Agreements ("SLAs"), etc. (e.g., maximum latency thresholds, minimum throughput thresholds, etc.) associated with the services.

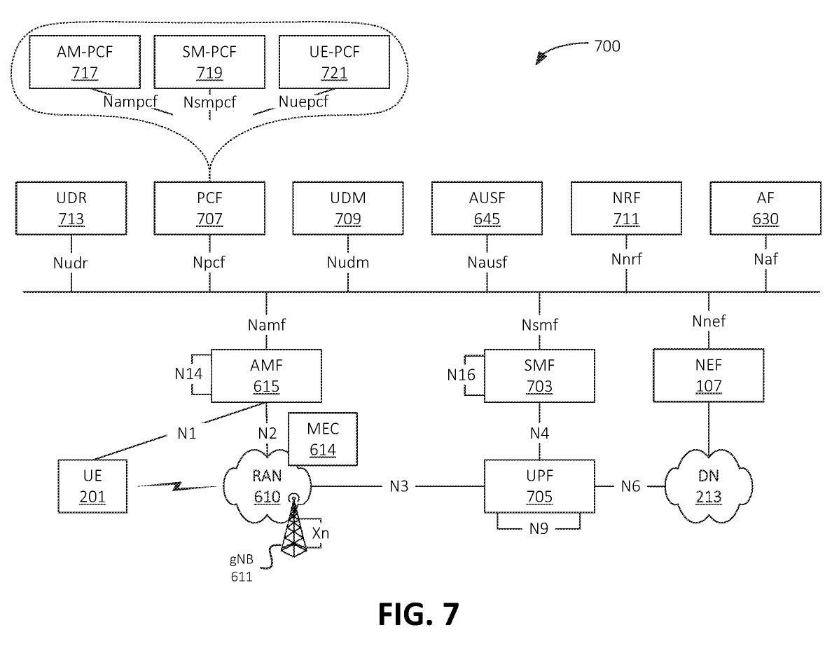

FIG. 7 illustrates another example environment 700, in which one or more embodiments may be implemented. In some embodiments, environment 700 may correspond to a 5G network, and/or may include elements of a 5G network. In some embodiments, environment 700 may correspond to a 5G SA architecture. In some embodiments, environment 700 may include a 5GC, in which 5GC network elements perform one or more operations described herein.

As shown, environment 700 may include UE 201, RAN 610 (which may include one or more gNBs 611 or other types of wireless network infrastructure) and various network functions, which may be implemented as VNFs, CNFs, etc. Such network functions may include AMF 615, SMF 703, UPF 705, PCF 707, UDM 709, AUSF 645, Network Repository Function ("NRF") 711, AF 630, UDR 713, and NEF 107. Environment 700 may also include or may be communicatively coupled to one or more networks, such as DN 213.

The example shown in FIG. 7 illustrates one instance of each network component or function (e.g., one instance of SMF 703, UPF 705, PCF 707, UDM 709, AUSF 645, etc.). In practice, environment 700 may include multiple instances of such components or functions. For example, in some embodiments, environment 700 may include multiple "slices" of a core network, where each slice includes a discrete and/or logical set of network functions (e.g., one slice may include a first instance of SMF 703, PCF 707, UPF 705, etc., while another slice may include a second instance of SMF 703, PCF 707, UPF 705, etc.). Additionally, or alternatively, one or more of the network functions of environment 700 may implement multiple network slices. The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include interfaces shown in FIG. 7 and/or one or more interfaces not explicitly shown in FIG. 7. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 700 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 615), an Nudm interface (e.g., indicating communications to be routed to UDM 709), an Npcf interface, an Nupf interface, an Nnef interface, an Nsmf interface, an Nnrf interface, an Nudr interface, an Naf interface, and/or one or more other SBIs.

UPF 705 may include one or more devices, systems, VNFs, CNFs, etc., that receive, route, process, and/or forward traffic (e.g., user plane traffic). As discussed above, UPF 705 may communicate with UE 201 via one or more communication sessions, such as PDU sessions. Such PDU sessions may be associated with a particular network slice or other suitable QoS parameters, as noted above. UPF 705 may receive downlink user plane traffic (e.g., voice call traffic, data traffic, etc. destined for UE 201) from DN 213, and may forward the downlink user plane traffic toward UE 201 (e.g., via RAN 610). In some embodiments, multiple UPFs 705 may be deployed (e.g., in different geographical locations), and the delivery of content to UE 201 may be coordinated via the N9 interface. Similarly, UPF 705 may receive uplink traffic from UE 201 (e.g., via RAN 610), and may forward the traffic toward DN 213. In some embodiments, UPF 705 may implement, may be implemented by, may be communicatively coupled to, and/or may otherwise be associated with UPF/PGW-U 635. In some embodiments, UPF 705 may communicate (e.g., via the N4 interface) with SMF 703, regarding user plane data processed by UPF 705 (e.g., to provide analytics or reporting information, to receive policy and/or authorization information, etc.).

PCF 707 may include one or more devices, systems, VNFs, CNFs, etc., that aggregate, derive, generate, etc. policy information associated with the 5GC and/or UEs 201 that communicate via the 5GC and/or RAN 610. PCF 707 may receive information regarding policies and/or subscriptions from one or more sources, such as subscriber databases (e.g., UDM 709, UDR 713, etc.), and/or from one or more users such as, for example, an administrator associated with PCF 707. In some embodiments, the functionality of PCF 707 may be split into multiple network functions or subsystems, such as access and mobility PCF ("AM-PCF") 717, session management PCF ("SM-PCF") 719, UE PCF ("UE-PCF") 721, and so on. Such different "split" PCFs may be associated with respective SBIs (e.g., AM-PCF 717 may be associated with an Nampcf SBI, SM-PCF 719 may be associated with an Nsmpcf SBI, UE-PCF 721 may be associated with an Nuepcf SBI, and so on) via which other network functions may communicate with the split PCFs. The split PCFs may maintain information regarding policies associated with different devices, systems, and/or network functions.

NRF 711 may include one or more devices, systems, VNFs, CNFs, etc. that maintain routing and/or network topology information associated with the 5GC. For example, NRF 711 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 713 may include one or more devices, systems, VNFs, CNFs, etc. that provide user and/or subscriber information, based on which PCF 707 and/or other elements of environment 700 may determine access policies, QoS policies, charging policies, or the like. In some embodiments, UDR 713 may receive such information from UDM 709 and/or one or more other sources.

NEF 107 include one or more devices, systems, VNFs, CNFs, etc. that provide access to information, APIs, and/or other operations or mechanisms of the 5GC to devices or systems that are external to the 5GC. NEF 107 may maintain authorization and/or authentication information associated with such external devices or systems, such that NEF 107 is able to provide information, that is authorized to be provided, to the external devices or systems. Such information may be received from other network functions of the 5GC (e.g., as authorized by an administrator or other suitable entity associated with the 5GC), such as SMF 703, UPF 705, a charging function ("CHF") of the 5GC, and/or other suitable network function. NEF 107 may communicate with external devices or systems (e.g., external devices 654) via DN 213 and/or other suitable communication pathways.

While environment 700 is described in the context of a 5GC, as noted above, environment 700 may, in some embodiments, include or implement one or more other types of core networks. For example, in some embodiments, environment 700 may be or may include a converged packet core, in which one or more elements may perform some or all of the functionality of one or more 5GC network functions and/or one or more EPC network functions. For example, in some embodiments, AMF 615 may include, may implement, may be implemented by, and/or may otherwise be associated with MME 616; SMF 703 may include, may implement, may be implemented by, and/or may otherwise be associated with SGW 617; PCF 707 may include, may implement, may be implemented by, and/or may otherwise be associated with a PCRF (e.g., PCF/PCRF 625); NEF 107 may include, may implement, may be implemented by, and/or may otherwise be associated with a SCEF (e.g., NEF/SCEF 649); and so on.

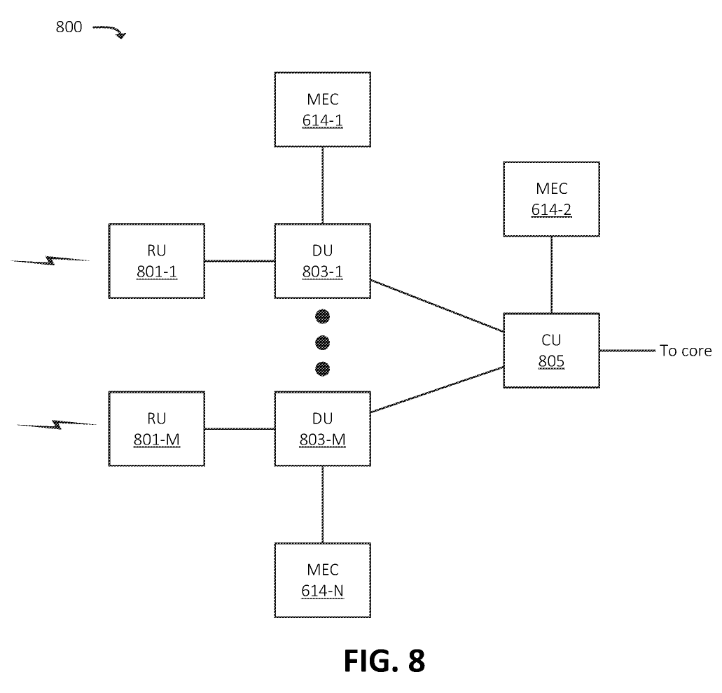

FIG. 8 illustrates an example RAN environment 800, which may be included in and/or implemented by one or more RANs (e.g., RAN 610 or some other RAN). In some embodiments, a particular RAN 610 may include one RAN environment 800. In some embodiments, a particular RAN 610 may include multiple RAN environments 800. In some embodiments, RAN environment 800 may correspond to a particular gNB 611 of RAN 610. In some embodiments, RAN environment 800 may correspond to multiple gNBs 611. In some embodiments, RAN environment 800 may correspond to one or more other types of base stations of one or more other types of RANs. As shown, RAN environment 800 may include CU 805, one or more DUs 803-1 through 803-M (referred to individually as "DU 803," or collectively as "DUs 803"), and one or more RUs 801-1 through 801-M (referred to individually as "RU 801," or collectively as "RUs 801").

CU 805 may communicate with a core of a wireless network (e.g., may communicate with one or more of the devices or systems described above with respect to FIG. 7, such as AMF 615 and/or UPF 705) and/or some other device or system such as MEC 614. In the uplink direction (e.g., for traffic from UEs 201 to a core network), CU 805 may aggregate traffic from DUs 803, and forward the aggregated traffic to the core network. In some embodiments, CU 805 may receive traffic according to a given protocol (e.g., Radio Link Control ("RLC") traffic) from DUs 803, and may perform higher-layer processing (e.g., may aggregate/process RLC packets and generate Packet Data Convergence Protocol ("PDCP") packets based on the RLC packets) on the traffic received from DUs 803.

CU 805 may receive downlink traffic (e.g., traffic from the core network, traffic from a given MEC 614, etc.) for a particular UE 201, and may determine which DU(s) 803 should receive the downlink traffic. DU 803 may include one or more devices that transmit traffic between a core network (e.g., via CU 805) and UE 201 (e.g., via a respective RU 801). DU 803 may, for example, receive traffic from RU 801 at a first layer (e.g., physical ("PHY") layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 201.

RU 801 may include hardware circuitry (e.g., one or more RF transceivers, antennas, radios, and/or other suitable hardware) to communicate wirelessly (e.g., via an RF interface) with one or more UEs 201, one or more other DUs 803 (e.g., via RUs 801 associated with DUs 803), and/or any other suitable type of device. In the uplink direction, RU 801 may receive traffic from UE 201 and/or another DU 803 via the RF interface and may provide the traffic to DU 803. In the downlink direction, RU 801 may receive traffic from DU 803, and may provide the traffic to UE 201 and/or another DU 803.

One or more elements of RAN environment 800 may, in some embodiments, be communicatively coupled to one or more MECs 614. For example, DU 803-1 may be communicatively coupled to MEC 614-1, DU 803-M may be communicatively coupled to MEC 614-N, CU 805 may be communicatively coupled to MEC 614-2, and so on. MECs 614 may include hardware resources (e.g., configurable or provisionable hardware resources) that may be configured to provide services and/or otherwise process traffic to and/or from UE 201, via a respective RU 801.

For example, DU 803-1 may route some traffic, from UE 201, to MEC 614-1 instead of to a core network via CU 805. MEC 614-1 may process the traffic, perform one or more computations based on the received traffic, and may provide traffic to UE 201 via RU 801-1. As discussed above, MEC 614 may include, and/or may implement, some or all of the functionality described above with respect to UPF 705, AF 630, and/or one or more other devices, systems, VNFs, CNFs, etc. In this manner, ultra-low latency services may be provided to UE 201, as traffic does not need to traverse DU 803, CU 805, links between DU 803 and CU 805, and an intervening backhaul network between RAN environment 800 and the core network.

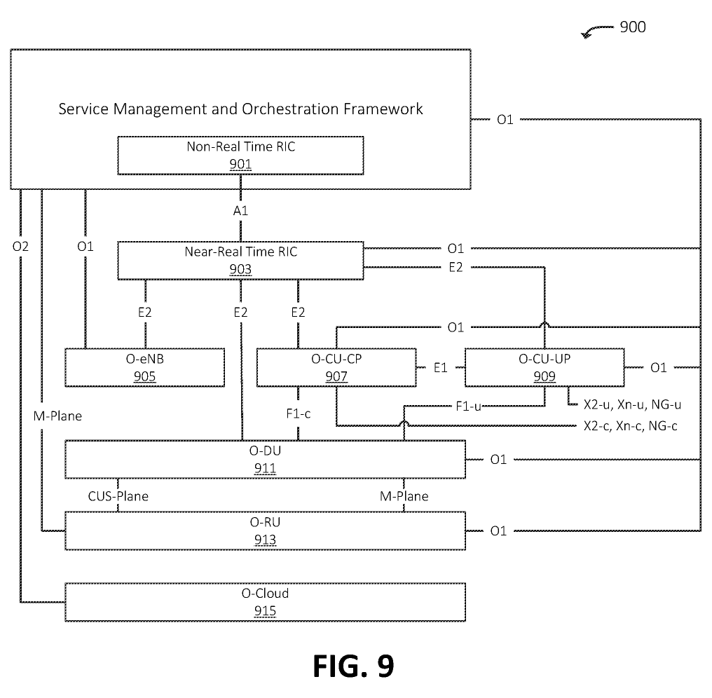

FIG. 9 illustrates an example O-RAN environment 900, which may correspond to RAN 610, RAN 612, and/or RAN environment 800. For example, RAN 610, RAN 612, and/or RAN environment 800 may include one or more instances of O-RAN environment 900, and/or one or more instances of O-RAN environment 900 may implement RAN 610, RAN 612, RAN environment 800, and/or some portion thereof. As shown, O-RAN environment 900 may include Non-Real Time RIC 901, Near-Real Time RIC 903, O-eNB 905, O-CU-Control Plane ("O-CU-CP") 907, O-CU-User Plane ("O-CU-UP") 909, O-DU 911, O-RU 913, and O-Cloud 915. In some embodiments, O-RAN environment 900 may include additional, fewer, different, and/or differently arranged components or interfaces.

In some embodiments, some or all of the elements of O-RAN environment 900 may be implemented by one or more configurable or provisionable resources, such as virtual machines, cloud computing systems, physical servers, and/or other types of configurable or provisionable resources. In some embodiments, some or all of O-RAN environment 900 may be implemented by, and/or communicatively coupled to, one or more MECs 614.

Non-Real Time RIC 901 and Near-Real Time RIC 903 may receive performance information (and/or other types of information) from one or more sources, and may configure other elements of O-RAN environment 900 based on such performance or other information. For example, Near-Real Time RIC 903 may receive performance information, via one or more E2 interfaces, from O-eNB 905, O-CU-CP 907, and/or O-CU-UP 909, and may modify parameters associated with O-eNB 905, O-CU-CP 907, and/or O-CU-UP 909 based on such performance information. Similarly, Non-Real Time RIC 901 may receive performance information associated with O-eNB 905, O-CU-CP 907, O-CU-UP 909, and/or one or more other elements of O-RAN environment 900 and may utilize machine learning and/or other higher level computing or processing to determine modifications to the configuration of O-eNB 905, O-CU-CP 907, O-CU-UP 909, and/or other elements of O-RAN environment 900. In some embodiments, Non-Real Time RIC 901 may generate machine learning models based on performance information associated with O-RAN environment 900 or other sources, and may provide such models to Near-Real Time RIC 903 for implementation.

In some embodiments, Non-Real Time RIC 901 and/or Near-Real Time RIC 903 may be communicatively coupled to NWDAF 101. For example, Non-Real Time RIC 901 and Near-Real Time RIC 903 may provide (e.g., at 102) performance and/or QoS information, associated with one or more RAN elements, to NWDAF 101. In some embodiments, NWDAF 101 may receive such information via an E2 interface included in O-RAN environment 900. For example, NWDAF 101 may request (e.g., subscribe to) network analytics information (e.g., performance and/or QoS information) received from O-CU-CP 907, O-CU-UP 909, and/or O-DU 911. In some embodiments, some or all of the functionality performed by Non-Real Time RIC 901 and Near-Real Time RIC 903 may be performed by NWDAF 101. In some embodiments, some or all of the functionality described above with respect to NWDAF 101 may be performed by Non-Real Time RIC 901 and Near-Real Time RIC 903.

O-eNB 905 may perform functions similar to those described above with respect to gNB 611 and/or eNB 613. For example, O-eNB 905 may facilitate wireless communications between UE 201 and a core network. O-CU-CP 907 may perform control plane signaling to coordinate the aggregation and/or distribution of traffic via one or more DUs 803, which may include and/or be implemented by one or more O-DUs 911, and O-CU-UP 909 may perform the aggregation and/or distribution of traffic via such DUs 803 (e.g., O-DUs 911). O-DU 911 may be communicatively coupled to one or more RUs 801, which may include and/or may be implemented by one or more O-RUs 913. In some embodiments, O-Cloud 915 may include or be implemented by one or more MECs 614, which may provide services, and may be communicatively coupled, to O-CU-CP 907, O-CU-UP 909, O-DU 911, and/or O-RU 913 (e.g., via an O1 and/or O2 interface).

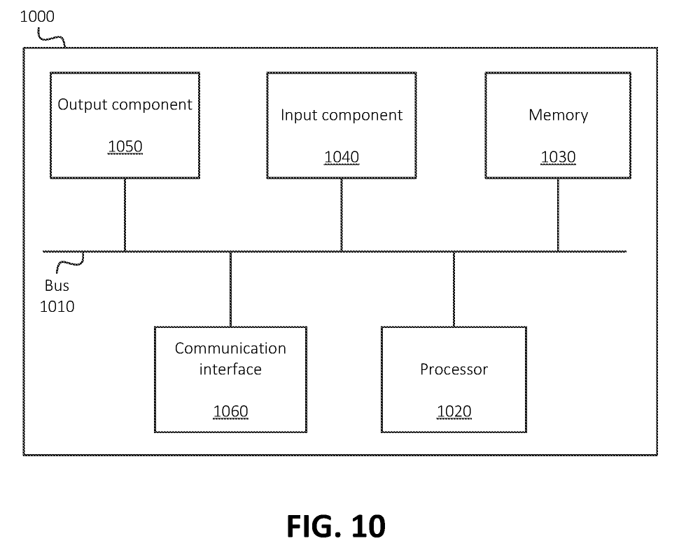

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, a graphics processing unit ("GPU"), a GPU-based processing unit, a neural processing unit ("NPU"), or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes ("LEDs"), etc.

Communication interface 1060 may include any transceiver-like mechanism that enables device 1000 to communicate with other devices and/or systems (e.g., via RAN 610, RAN 612, DN 213, etc.). For example, communication interface 1060 may include an Ethernet interface, an optical interface, a coaxial interface, or the like. Communication interface 1060 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
monitor performance information associated with a wireless network, wherein the performance information is associated with traffic sent or received by one or more User Equipment ("UEs") via the wireless network;
generate one or more predictive models based on the monitored performance information;
receive a request for Quality of Service ("QoS") capability information;
determine, based on the one or more predictive models, conditions under which the wireless network is able to meet one or more QoS thresholds associated with the request; and
output, in response to the request, an indication of the conditions under which the wireless network is able to meet the one or more QoS thresholds.

2. The device of claim 1, wherein the conditions under which the wireless network is able to meet the one or more QoS thresholds include at least one of:
a time at which the wireless network is able to meet the one or more QoS thresholds,
a location at which the wireless network is able to meet the one or more QoS thresholds, or
a network slice of the wireless network that is able to meet the one or more QoS thresholds.

3. The device of claim 1, wherein meeting, by the wireless network, the one or more QoS thresholds includes meeting a threshold Quality of Experience ("QoE") score that is based on the one or more QoS thresholds.

4. The device of claim 1, wherein receiving the request and outputting the indication in response to the request are performed by a Network Data Analytics Function ("NWDAF").

5. The device of claim 1, wherein the request specifies the one or more QoS thresholds, wherein the one or more processors are further configured to determine, based on the one or more predictive models, that the one or more QoS thresholds are unable to be met by the wireless network,
wherein determining the conditions under which the wireless network is able to meet the one or more QoS thresholds associated with the request is performed based on determining that the one or more QoS thresholds are unable to be met by the wireless network.

6. The device of claim 5, wherein the request further specifies a first timeframe, wherein determining the conditions under which the wireless network is able to meet the one or more QoS thresholds associated with the request includes determining a second timeframe during which the wireless network is able to meet the one or more QoS thresholds specified in the request.

7. The device of claim 5, wherein the request further specifies a first location, wherein determining the conditions under which the wireless network is able to meet the one or more QoS thresholds associated with the request includes determining a second location at which the wireless network is able to meet the one or more QoS thresholds specified in the request.

8. A non-transitory computer-readable medium, storing a plurality of processor-executable instructions to:
monitor performance information associated with a wireless network, wherein the performance information is associated with traffic sent or received by one or more User Equipment ("UEs") via the wireless network;
generate one or more predictive models based on the monitored performance information;
receive a request for Quality of Service ("QoS") capability information;
determine, based on the one or more predictive models, conditions under which the wireless network is able to meet one or more QoS thresholds associated with the request; and
output, in response to the request, an indication of the conditions under which the wireless network is able to meet the one or more QoS thresholds.

9. The non-transitory computer-readable medium of claim 8, wherein the conditions under which the wireless network is able to meet the one or more QoS thresholds include at least one of:
a time at which the wireless network is able to meet the one or more QoS thresholds,
a location at which the wireless network is able to meet the one or more QoS thresholds, or
a network slice of the wireless network that is able to meet the one or more QoS thresholds.

10. The non-transitory computer-readable medium of claim 8, wherein meeting, by the wireless network, the one or more QoS thresholds includes meeting a threshold Quality of Experience ("QoE") score that is based on the one or more QoS thresholds.

11. The non-transitory computer-readable medium of claim 8, wherein receiving the request and outputting the indication in response to the request are performed by a Network Data Analytics Function ("NWDAF").

12. The non-transitory computer-readable medium of claim 8, wherein the request specifies the one or more QoS thresholds, wherein the plurality of processor-executable instructions further include processor-executable instructions to determine, based on the one or more predictive models, that the one or more QoS thresholds are unable to be met by the wireless network,
wherein determining the conditions under which the wireless network is able to meet the one or more QoS thresholds associated with the request is performed based on determining that the one or more QoS thresholds are unable to be met by the wireless network.

13. The non-transitory computer-readable medium of claim 12, wherein the request further specifies a first timeframe, wherein determining the conditions under which the wireless network is able to meet the one or more QoS thresholds associated with the request includes determining a second timeframe during which the wireless network is able to meet the one or more QoS thresholds specified in the request.

14. The non-transitory computer-readable medium of claim 12, wherein the request further specifies a first location, wherein determining the conditions under which the wireless network is able to meet the one or more QoS thresholds associated with the request includes determining a second location at which the wireless network is able to meet the one or more QoS thresholds specified in the request.

15. A method, comprising:
monitoring performance information associated with a wireless network, wherein the performance information is associated with traffic sent or received by one or more User Equipment ("UEs") via the wireless network;
generating one or more predictive models based on the monitored performance information;
receiving a request for Quality of Service ("QoS") capability information;
determining, based on the one or more predictive models, conditions under which the wireless network is able to meet one or more QoS thresholds associated with the request; and
outputting, in response to the request, an indication of the conditions under which the wireless network is able to meet the one or more QoS thresholds.

16. The method of claim 15, wherein the conditions under which the wireless network is able to meet the one or more QoS thresholds include at least one of:
a time at which the wireless network is able to meet the one or more QoS thresholds,
a network slice of the wireless network that is able to meet the one or more QoS thresholds, or
a location at which the wireless network is able to meet the one or more QoS thresholds, wherein the location includes at least one of:
a Tracking Area Code ("TAC"),
a Location Area Code ("LAC"),
a Routing Area Code ("RAC"), or
a cell identifier.

17. The method of claim 15, wherein receiving the request and outputting the indication in response to the request are performed by a Network Data Analytics Function ("NWDAF").

18. The method of claim 15, wherein the request specifies the one or more QoS thresholds, the method further comprising determining, based on the one or more predictive models, that the one or more QoS thresholds are unable to be met by the wireless network,
wherein determining the conditions under which the wireless network is able to meet the one or more QoS thresholds associated with the request is performed based on determining that the one or more QoS thresholds are unable to be met by the wireless network.

19. The method of claim 18, wherein the request further specifies a first timeframe, wherein determining the conditions under which the wireless network is able to meet the one or more QoS thresholds associated with the request includes determining a second timeframe during which the wireless network is able to meet the one or more QoS thresholds specified in the request.

20. The method of claim 18, wherein the request further specifies a first location, wherein determining the conditions under which the wireless network is able to meet the one or more QoS thresholds associated with the request includes determining a second location at which the wireless network is able to meet the one or more QoS thresholds specified in the request.
